(19) United States
(12) Patent Application Publication
(10) Pub. No.: US 2011/0080476 A1
(43) Pub. Date: Apr. 7, 2011

(54) High Performance Vision System for Part Registration

(75) Inventors: William Dinauer, Hudson, WI (US); Thomas Weigman, Perrysburg, OH (US)

(73) Assignee: LASX INDUSTRIES, INC., St. Paul, MN (US)

(21) Appl. No.: 12/897,034

(22) Filed: Oct. 4, 2010

Related U.S. Application Data
(60) Provisional application No. 61/248,308, filed on Oct. 2, 2009.

(51) Int. Cl. H04N 7/18; G06K 9/00

(52) U.S. Cl. 348/86; 382/141; 348/E07.085

(57) ABSTRACT

An embodiment describes a vision system capable of inspecting large areas with high accuracy and speed. According to embodiments, a more sophisticated system is used that allows the camera to see the entire workpiece surface. Prior art devices used cameras with a fixed field-of-view. This causes problems with finding parts accurately all over the field, especially when their locations are not known or they exist outside of the fixed field-of-view of a camera. An embodiment uses our scanner scheme described in detail above that can find fiducial marks accurately over the entire workpiece.) A calibration is used to correct for perspective distortions that occur from viewing the fiducial marks from the skewed angles. The calibration also corrects for various errors in several possible optical configurations.

This application claims priority from provisional application No. 61/248,308, filed Oct. 2, 2009, the entire contents of which are herewith incorporated by reference.

### BACKGROUND

Machine vision systems are used in a variety of industries worldwide. In recent years, significant advancements in machine vision systems have lead to their proliferation, specifically in manufacturing operations for use in inspection and registration of manufactured parts.

LasX Industries, the assignee of the present application, uses machine vision systems to find part to accurately laser cut each part passing though the laser system. Their current machine vision scheme uses one or more fixed field-of-view (FOV) cameras that locate fiducial or registration marks only under the camera's FOV. If a fiducial mark falls out of the camera's FOV, the machine vision system cannot be effectively used.

LasX's LaserSharp® Processing Module is sold as a sub-system for integrated material handling systems, whether in roll, sheet, or part format. This may use CO2 or fiber lasers coupled with galvanometer motion systems. One embodiment will be described as being used with a Lasx LaserSharp® Processing module, but the invention is not limited to said module.

### SUMMARY

An embodiment describes a vision system capable of inspecting larger areas with high accuracy and speed then a conventional machine vision system using one or more cameras each with a limited field-of-view (FOV). According to embodiments, a more sophisticated system is used that allows one or more cameras to rapidly inspect the entire part, addressing the limited FOV problem found in conventional machine vision systems.

An embodiment describes a vision system which is capable of measuring the location of fiducial marks by utilizing the camera's FOV reflected off two galvanometer mounted mirrors. The system can operate with a single camera according to one embodiment, where the moving mirrors can steer the optical path from the camera to any point on the work surface.

### BRIEF DESCRIPTION OF THE DRAWINGS

FIGS. 1A, 1B and 1C show a vision system according to an embodiment, with FIGS. 1A and 1B showing the general structure, and FIG. 1C showing the embodiment incorporated into a laser processing module;

FIG. 2 shows an optical layout of post-objective scanning;

FIG. 3 shows an optical layout of pre-objective scanning; and

FIG. 4 shows the layout of a prior art vision system using fixed field-of-view cameras to image fiducial marks for a laser system; and;

FIGS. 5A and 5B illustrate the systems accuracy error as a function of mirror position.

### DETAILED DESCRIPTION

A fiducial or registration mark can be a small mark, such as a cross, circle, or square at a location of interest. In another embodiment, the fiducial can be a specified pattern of dots, e.g. five small dots grouped together. In the laser system used by LasX Industries, fiducial marks are positioned around a part to be laser cut. A computer system images those fiducial marks in order to computer the location and orientation of the workpiece. Location and orientation of the workpiece can be used to determine how to process the workpiece.

An embodiment places fiducial marks on the item being processed, and uses a vision system to determine the location of the fiducial marks. According to an embodiment, a single camera can be used to determine multiple items of information on the workpiece.

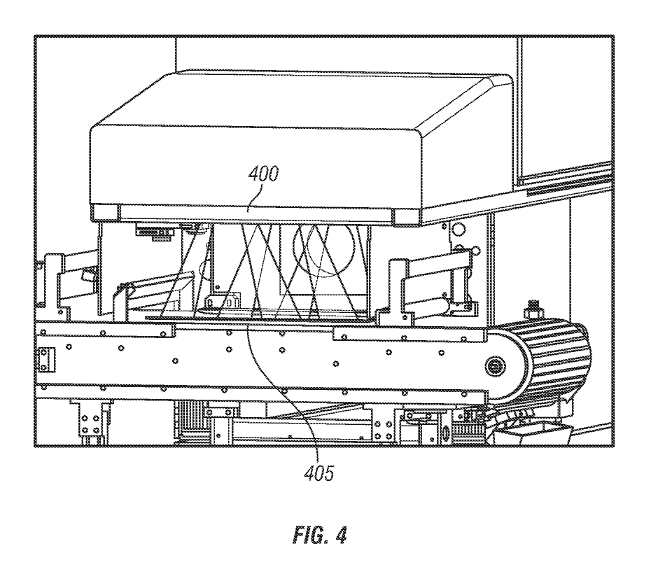

Many of LasX's laser systems have a conveyer belt feeding materials underneath a laser's cutting field. One or more cameras are then mounted upstream to image the parts before they reach the cutting field, as shown in the existing fixed FOV camera method shown in FIG. 4. Accurately finding the part's location and orientation is important because it is not guaranteed the part will be loaded on the conveyer in the correct position. In the present embodiment, a preferable value is to determine the location of the part to be known to within 50 microns; otherwise the laser cuts will not meet many customers' accuracy needs. If the fiducial mark is out of the camera's FOV, the part will be missed and does not get cut or not get cut properly.

According to embodiments, a workpiece processing system is described. In one embodiment, this workpiece processing system may be a laser processing system, which determines how and where to cut or otherwise process a workpiece using a laser. While the embodiment refers to a laser processing system, another embodiment may use this in inkjet printing to print on a location based on accurately determining the location of the workpiece. Another embodiment may use this in robotic assembly. This system, in general, can be used in any embodiment where there can be accurate and rapid location of the workpiece and that is used to process the workpiece. The term “workpiece processing” or the like is intended to be generic to any and all such applications.

One embodiment produces an output of a fiducial or registration mark's “world location” within less than 50 microns using a single camera that can be steered to different locations on the workpiece.

Embodiments may achieve an accuracy limited by only the scanner's precision and drift specification and its height off the work surface, optics setup, and accuracy of object recognition image processing techniques. The system therefore has the ability to achieve higher accuracies than 50 microns using other hardware and/or software.

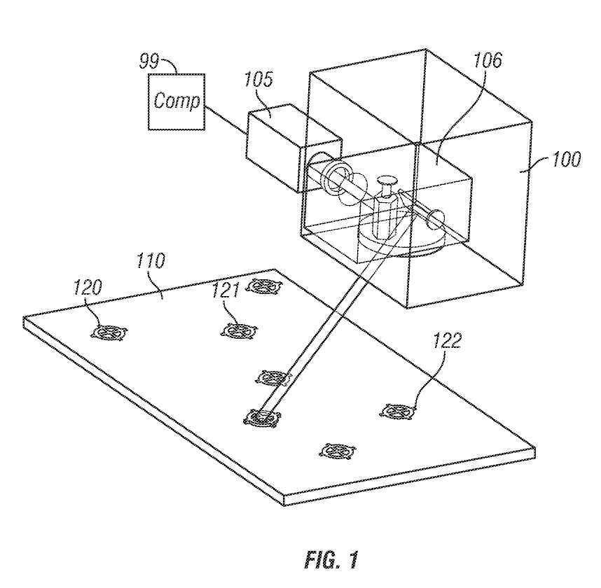

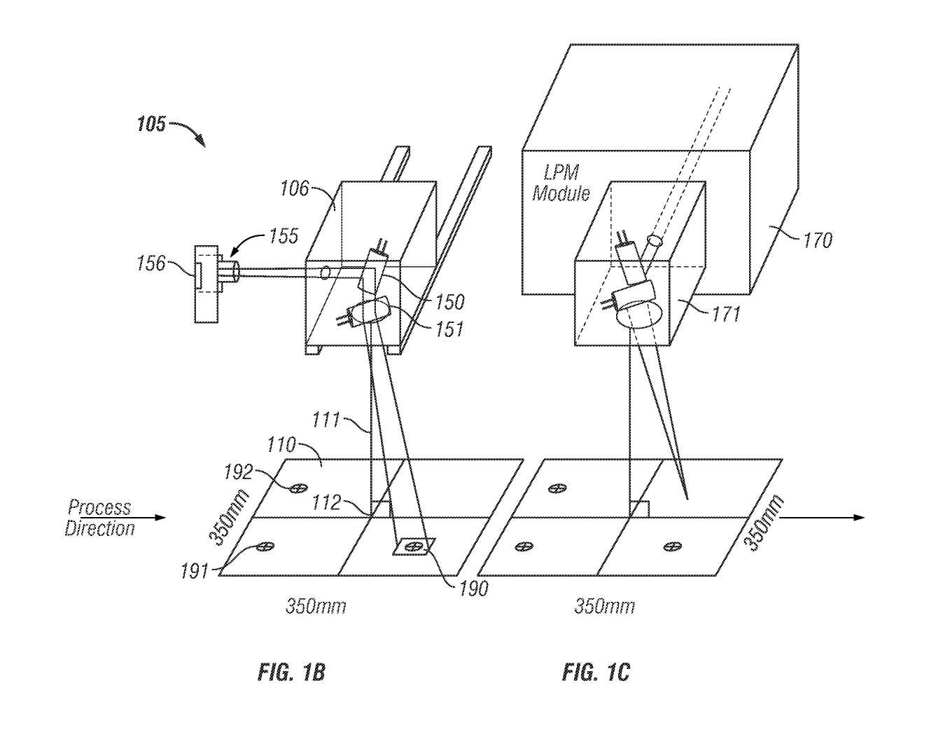

According to an embodiment, a single camera can be used to find fiducial marks on a workpiece at a number of different locations as shown in FIGS. 1A, 1B and 1C. Additional cameras and optics may be used depending on the application, in other embodiments. A number of problems which were noticed in the prior art have been addressed by the present application.

The inventors noticed that the fiducial marks must be in certain locations near the location of camera when using the prior art system. The present inventors realize that using a scanhead to rapidly direct the field-of-view of a camera over an entire workpiece could acquire the same information as a fixed FOV camera.

Another problem noted during the determination of this embodiment is that if the fiducial mark is imaged from a specified kind of side view, then it will no longer look the way it was intended to look; it will be skewed by the extreme angle. The present application describes ways of compensating for that skew/distortion.

Embodiments may also compensate for the change in magnification over the workpiece when using convex optics as well.

According to the present embodiment, the fiducial marks are found and then laser processing (or other workpiece processing) is carried out based on a location relative to the location of the fiducial marks. Control of the laser beam is achieved by focusing the beam onto the cutting field after passing it through a scanhead 106.

The scanhead 106 has two galvanometer mounted mirrors 150, 151 inside, one of which controls a beam's X motion and the other of which controls its Y-axis motion. The high resolution and torque offered by galvanometer motors allow the mirrors to be quickly and precisely positioned. A laser cutting system, e.g. Lasx LaserSharp® Processing module 170 can be used in conjunction with this vision system as shown in FIG. 1C. In the case of using this system for laser processing, the scanner 171 may be the scanner used by the laser processing module. The system can also use techniques as described in our U.S. patent Ser. No. 11/048,424, the disclosure of which is herewith incorporated by reference.

The embodiment of FIG. 1A shows the camera and processing assembly 100 in a location where it can scan information from the surface of the workpiece 110 to camera 105. FIG. 1B shows further detail of components of the system, including the lens 155 and image sensor 156 making up the camera 105. In one embodiment, the image sensor 156 can be a charge coupled device (CCD), or a complimentary metal-oxide semiconductor (CMOS), in a 2D (area scan) or 1D (line scan) style sensor format. An output of the camera assembly 105 is coupled to a computer that processes the information and controls processing of a workpiece 110.

The workpiece 110 itself includes a number of fiducial marks shown as 120, 121, 122. The fiducial marks have a special layout as shown in FIG. 1A, of a circle mixed in with a cross. However, other fiducial marks can be monitored by the system. More generally, the fiducial marks such as 120 can be any feature that can be imaged or read by the computer 99. This may be a very important point, since existing methods require a defined mark, while the present system can use any mark that is desirable. Any unique feature that is printed on the workpiece can be seen by the computer 99 and compared with a template indicative of the fiducial mark. For example, in one embodiment, an image of the fiducial mark may be stored in the computer 99. As the camera assembly 105 images the various locations on the surface, it cross correlates these areas on the surface with the stored image of the fiducial mark. Cross correlation values greater than a certain amount indicates a match between the area imaged and the fiducial mark that was defined as being the fiducial mark.

The scanhead can be calibrated to the field using a conventional grid calibration. Thus, the world location of the center of the camera's FOV (shown in FIG. 1B as 112) is known.

Once the fiducial mark is detected on the camera's image sensor, the distance offset from the center of the camera's FOV to the fiducial mark (X_{c}, Y_{c}) can be calculated using a pre-calibrated pixel to world ratio and perspective distortion corrections. Finally, adding these quantities yields the world coordinates of the fiducial mark.

X_{scanhead}+X_{Camera}=X_{World} (Eqn. 1)

Y_{scanhead}+Y_{Camera}=Y_{World} (Eqn. 2)

A spiral search algorithm may be used to start at an approximate fiducial mark location and spiral outward if the fiducial mark is not initially in the camera's FOV. Note that other search pattern algorithms can be used to locate the fiducial mark.

In one embodiment, the laser processing may include cutting the workpiece at locations relative to the found locations of the fiducial mark. The laser processing may include for example cutting the workpiece. The fiducial marks may be located close to the edge of the workpiece, so that the laser processing carried out after determining the location of the fiducial marks cuts off those marks as part of the laser processing.

In one embodiment, the application can use a standard 2D camera sensor to expose the image.

In another embodiment, the application can use a linescan (1D pixel array) camera to achieve resolution higher than that of a standard 2D camera. This is accomplished by a single axis mirror sweep of one of the mirrors while sending encoder quadrature (or any output representative of an encoder pulse) to the image acquisition device of the linescan camera. This can also be accomplished by the mirrors holding still at a certain location while having the material move under the scanhead. The mechanism moving the fiducials under the scanhead may use an encoder output to track the position for linescan image acquisition. The encoder output is generated as a function of the position of the scanhead or the motion mechanism moving the fiducials. That output is compensated, e.g., it can be divided or multiplied and sent out to the camera's acquisition device to attain the correct field resolution to the orthogonal axis of the linescan image. Correct field resolution is a function of encoder output, and the optics mounted to the camera. One of the many benefits of the linescan application is that larger field images can be attained, while still maintaining a significant resolution improvement over a standard area scan camera sensor.

The camera can scan over a very large location or area. The inventors recognize, however, that scanning over this very large area can itself creates distortions, which may have been the reason that previous systems did not use this kind of large areas scanning. For example, when scanning towards the outer edges of the camera's field, the fiducial marks and camera view becomes skewed because of the perspective difference. A perspective transformation is used to adjust for distortion errors that are based on calibration data taken during system setup. This operation allows more accurate location of fiducial marks. The distortion error is not constant throughout the whole field, thus the compensation incorporates several perspective transforms integrated with bilinear interpolation to de-skew the image, as described herein.

In one embodiment, fiducial marks may be located at opposite corners of the material at known locations. For the workpiece 110, for example, it may be pre-known that two fiducial marks are at the locations 120 and 122 at opposite corners of the workpiece. In the embodiment, the camera images these general locations, looking for these two fiducial marks in these locations. The areas may be scanned and cross correlated to find the locations. For example, FIG. 1B illustrates the scanner 106 finding a first fiducial mark 190 in a first area of the workpiece 110. In this embodiment, the world location of the center of the camera's FOV is shown as a normal line 111 that is perpendicular to the center point 112 on the workpiece. This defines, therefore, an angle between the center line on the workpiece, and the imaged area of the fiducial mark 190. Note that there are other fiducial marks 191, 192 in other areas of the workpiece.

The fiducial marks can be used to find the location and orientation of the workpiece: X, Y, and theta in one embodiment. In another embodiment, data can be used to find locations in 4 dimensions: X, Y, Z, and time.

In yet another embodiment, a three-dimensional operation can be carried out. In this embodiment, the system keeps track of six variables of location. This may include X, Y, and theta, and also the Z-dimension value, roll angle, and pitch angle. Monitoring and control in 3D can be used to more accurately control the 2D surface by referencing the workpiece against a work support, e.g., the conveyor belt as described above. By controlling in three dimensions, the work support is accurately located to compensate for its 3 dimensional characteristics. For example, the workpiece might be skewed on the surface, might not be completely flat against the surface, or might be somewhat warped, that is not completely flat. By monitoring in 3 dimensions, all of these characteristics can be compensated such that the z-dimension value is a constant value (or is compensated to be constant) and that the roll and pitch angles are zero.

These techniques can also extend to another embodiment in which the workpiece itself is intentionally three-dimensional, and additional information is used to locate information about the surface of that three-dimensional workpiece. For example, this can operate with an embodiment in which three dimensional features are intentionally place on the workpiece surface.

Monitoring in three dimensions may use any 3 degrees of freedom, including roll angle, pitch angle, and yaw angle. By knowing the general region of interest, however, a faster scanning can be carried out.

Typically, workpieces being processed in this way, are created according to computer-aided drawing templates. When that is eon, the shape of the workpiece and the location of the fiducial marks on the workpiece, is known from the CAD file of the workpiece. In one embodiment, the vision acquisition is carried out from stationary camera and the light is steered into the camera's CCD using moving mirrors located outside of the camera i.e. galvanometer scanner.

The above has described a camera and processing assembly 100 which includes a camera part 105 and other galvanometer scanner or light steering equipment 106. In another embodiment, two cameras can be used to capture the fiducial marks on the moving web, where each of the cameras may have the characteristics described herein, and each of the cameras may include an output that is processed to compensate for said shape distortion.

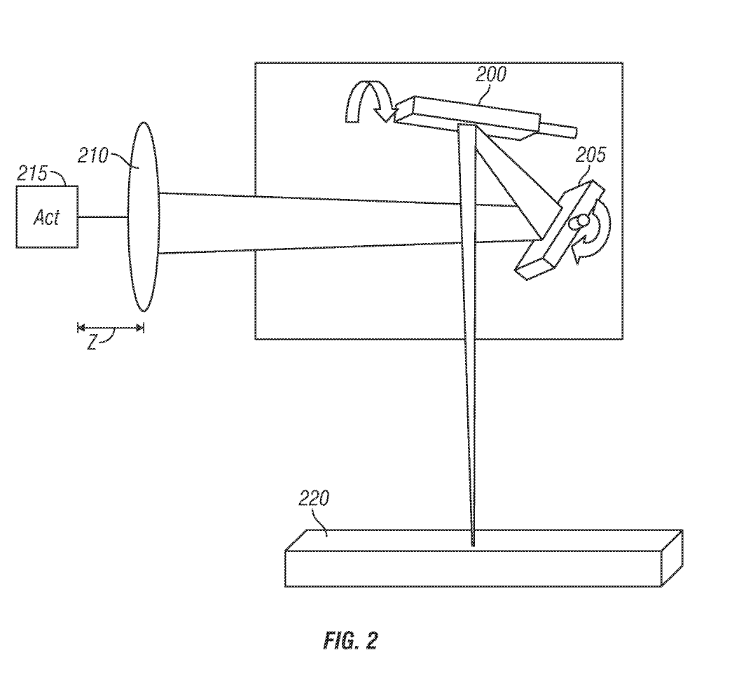

An embodiment may use a scan head with post-objective scanning as shown in FIG. 2. This allows for large areas to be processed at one time for very high speed processing.

F-theta and telecentric lenses are typically used in a pre-objective scanner where these lenses are after the rotating mirrors. Post-objective scanning as shown in FIG. 2 uses a lens assembly 210 prior to the rotating mirrors. In most cases the post-objective lens assembly has two lens parts, one of which is moved via a linear motor coaxial with the optical axis to automatically adjust for different focal lengths between the camera (or laser) to the workpiece. Focal lengths change due to rotating mirrors varying the optical axis to the workpiece).

In this embodiment, the movable mirrors 202 and 205 are placed between the final objective focusing lens 210 and the workpiece 220. The image (and illumination) from the workpiece 220 is then steered by the moving mirrors 200 and 205 to the imaging or focus lens assembly 210 into camera 215. This embodiment which uses post objective scanning is more flexible in that this also allows the position of the lens 210 to be moved in the Z-axis direction by a Z-axis actuator. This can change the focus level on the surface, and in essence enables three-dimensional scanning. Often times tight tolerance parts is accomplished with vision acquisition.

However for any given mirror angle, all light rays that are off the optical axis would be subject to “fisheye” distortion. This distortion can be removed with additional image processing. A single convex lens has also been proven to work.

One form of distortion described above depends on the specific optical setup used and can be compensated with system calibration and image processing.

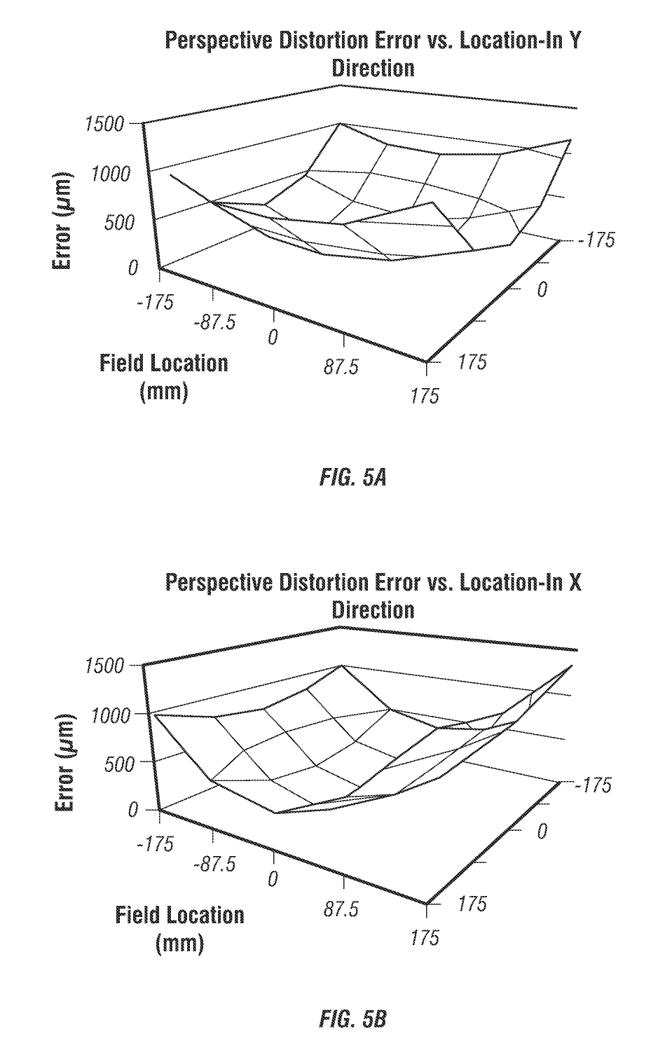

One problem is the camera system's perspective distortion. For example, when the scanhead is looking directly down at a circular fiducial mark (optical axis normal to the work surface) that fiducial mark will appear, properly, as a circle. However, when the scanhead mirrors face out toward the edge of the field, this circle will appear as a teardrop or an ellipse based on perspective distortion. This perspective distortion causes pixel measurements on the camera's CCD to be out of specification. FIGS. 5A and 5B show data taken detailing the amount of error found in measurements if the perspective distortion and “zoom” distortion/field position. This error is due to perspective distortion and is compounded by not compensating for the changing pixel to world ratio throughout the working field. The pixel to world ratio can be thought of as “zoom error” that is inherent in using convex optics for imaging. This distortion, causes the pixel to world “distance” ratio changes as a function of mirror angle were not accounted for in the image. Affine transformations can be used, as a means to eliminate or reduce the perspective distortion. An affine transformation of an image out near the edge of the field would result in rotating that image about the point where the lens's chief ray meets the work surface. The image would then appear to be normal to the camera's CCD and thus remove the perspective distortion. According to one embodiment, calibration is used to improve the system operation. Affine transformations could be calibrated in a similar way the perspective distortions are calibrated in above said embodiments.)

In practice, in order to rotate the image data the correct amount at any position, the transformation matrix may contain data about the precise angle to rotate. Although the mirror positions are “known,” assumption about the scanhead's orientation to the workpiece below may be difficult to make. When processing in three dimensions, the scanhead may not be aligned perfectly parallel to the work surface, and may not be the perfect height. The Z dimension, roll and pitch angles discussed above can be used to process these values. Since the geometric parameters will not be known to high accuracy, the rotation angle calculation will often be inaccurate.

Another embodiment uses pre-objective scanning and telecentric lens system mounted on the camera. A telecentric lens is a multi-element lens assembly that provides the lens's entrance and exit pupil at infinity. This allows for small focus spot sizes and tight tolerance parts. One such system has a tolerance of ±10 μm with a standard deviation of 1 μm. A limitation of the telecentric lens is that field size is limited to the clear aperture of the scanhead. It is also believed that a telecentric lens could be too expensive for many applications. A single element F-theta lens can also be used between the scanhead and the work surface. The F-Theta lens would be advantageous because of its lower cost.**

While this is one system of operation, there are other optics schemes available that offer different advantages and disadvantages. All could be calibrated and used to find the locations of fiducial marks quickly and accurately.

In yet another embodiment, the invention could be used with a high accuracy “laser calibration plate” in order to allow a system to perform “self calibration” of its scanners. Such maintenance is required regularly in high precision applications and is currently done by hand with an off-site measurement tool.

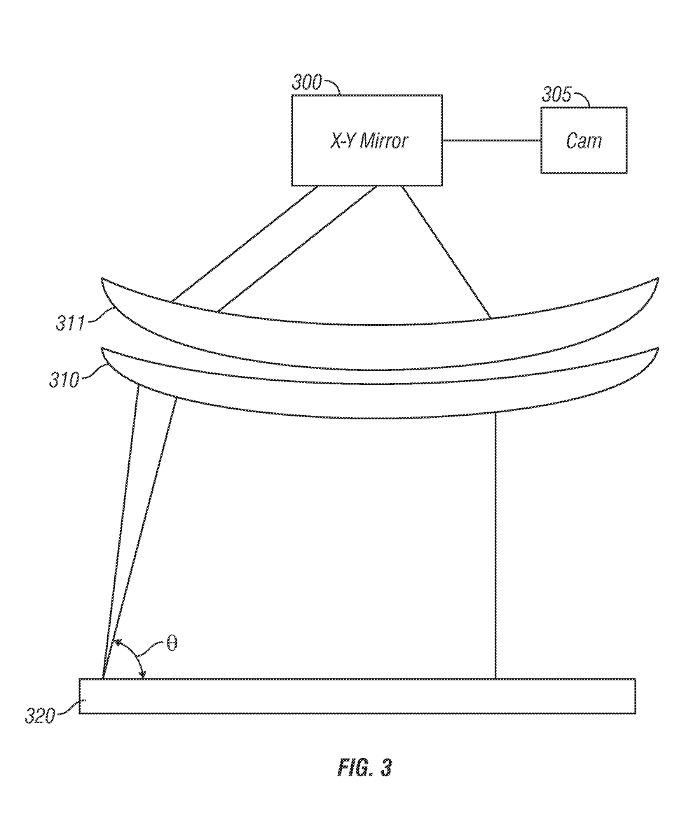

Pre-objective scanning shown in FIG. 3 has the focusing lens assembly 310 located optically downstream of the X-Y mirrors. The lens in this case may be a wide field-of-view lens, which enables the camera's optical path to be moved to any of a number of different directions and still be focused on to the workpiece. For example, the XY mirrors 300 are shown in optical communication with the camera 305. The output positioning of those XY mirrors can be located to any different of a number of different locations on the lens group 310. When light is sent through one surface 311 of the lens group 310, these are focused down to the workpiece 320, with one optical axis showing the illumination and the other beam showing the return. Pre-objective scanning typically enables processing on 2D workpiece surfaces only.

By using a lens group, the value phi representing the angle of incidence does not change greatly throughout the processing plane.

According to an embodiment, an approximate angle determination is made indicative of the distortion. The approximated angle determination is used to determine which interpolated perspective transformation to use. In one embodiment, transformations are used on all images whether or not the chief ray is normal to the workpiece. Although the perspective is not an issue in that case, pixel to world ratios might be always applied for example.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, while the above describes perspective transformations, other transformations such as affine, non-linear, and radial versions can be used for image position correction.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments of the invention.

The various illustrative logical blocks, modules, and circuits described in connection with the embodiments disclosed herein, may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. The processor can be part of a computer system that also has a user interface port that communicates with a user interface, and which receives commands entered by a user, has at least one memory (e.g., hard drive or other comparable storage, and random access memory) that stores electronic information including a program that operates under control of the processor and with communication via the user interface port, and a video output that produces its output via any kind of video output format, e.g., VGA, DVI, HDMI, displayport, or any other form.

When operated on a computer, the computer may include a processor that operates to accept user commands, execute instructions and produce output based on those instructions. The processor is preferably connected to a communication bus. The communication bus may include a data channel for facilitating information transfer between storage and other peripheral components of the computer system. The communication bus further may provide a set of signals used for communication with the processor, including a data bus, address bus, and/or control bus.

The communication bus may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or any old or new standard promulgated by the Institute of Electrical and Electronics Engineers (“IEEE”) including IEEE 488 general-purpose interface bus (“GPIB”), and the like.

A computer system used according to the present application preferably includes a main memory and may also include a secondary memory. The main memory provides storage of instructions and data for programs executing on the processor. The main memory is typically semiconductor-based memory such as dynamic random access memory (“DRAM”) and/or static random access memory (“SRAM”). The secondary memory may optionally include a hard disk drive and/or a solid state memory and/or removable storage drive for example an external hard drive, thumb drive, a digital versatile disc (“DVD”) drive, etc.

A least one possible storage medium is preferably a computer readable medium having stored thereon computer executable code (i.e., software) and/or data thereon in a non-transitory form. The computer software or data stored on the removable storage medium is read into the computer system as electrical communication signals.

The computer system may also include a communication interface. The communication interface allows' software and data to be transferred between computer system and external devices (e.g. printers), networks, or information sources. For example, computer software or executable code may be transferred to the computer to allow the computer to carry out the functions and operations described herein.

Computer system from a network server via communication interface. The communication interface may be a wired network card, or a Wireless, e.g., Wifi network card.

Software and data transferred via the communication interface are generally in the form of electrical communication signals.

Computer executable code (i.e., computer programs or software) are stored in the memory and/or received via communication interface and executed as received. The code can be compiled code or interpreted code or website code, or any other kind of code.

A “computer readable medium” can be any media used to provide computer executable code (e.g., software and computer programs and website pages), e.g., hard drive, USB drive or other. The software, when executed by the processor, preferably causes the processor to perform the inventive features and functions previously described herein.

A processor may also be implemented as a combination of computing devices, e.g., a combination of a DSP and a microprocessor, a plurality of microprocessors, one or more microprocessors in conjunction with a DSP core, or any other such configuration. These devices may also be used to select values for devices as described herein.

The steps of a method or algorithm described in connection with the embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. The memory storage can also be rotating magnetic hard disk drives, optical disk drives, or flash memory based storage drives or other such solid state, magnetic, or optical storage devices. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. The computer readable media can be an article comprising a machine-readable non-transitory tangible medium embodying information indicative of instructions that when performed by one or more machines result in computer implemented operations comprising the actions described throughout this specification.

Operations as described herein can be carried out on or over a website. The website can be operated on a server computer, or operated locally, e.g., by being downloaded to the client computer, or operated via a server farm. The website can be accessed over a mobile phone or a PDA, or on any other client. The website can use HTML code in any form, e.g., MHTML, or XML, and via any form such as cascading style sheets (“CSS”) or other.

Also, the inventors intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The programs may be written in C, or Java, Brew or any other programming language. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by anywhere between 20-50% while still staying within the teachings of the present application, unless some different range is specifically mentioned. Where a specified logical sense is used, the opposite logical sense is also intended to be encompassed.

The previous description of the disclosed exemplary embodiments is Provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A workpiece processing system, comprising:
a camera, which receives information indicative of an area being imaged on a workpiece, and produces an output indicative thereof;
a scanhead, that is controllable to change a camera imaging location where the camera carries out its imaging;
a processor, receiving said output from said camera, and processing said output to find a specified fiducial mark in said output representative of a fiducial mark location of said specified fiducial mark on said workpiece, and to image process said output to compensate for shape distortion in said output from said camera, said processor using said fiducial mark location of said specified fiducial mark to determine a workpiece location and workpiece orientation based on both said finding said fiducial mark and said compensate for shape distortion; and
a workpiece processing system, that processes said workpiece based on said information about both said location and orientation of said workpiece determined from said processor.

2. A system as in claim 1, wherein said processor finds two of said fiducial marks at two locations on the workpiece, including a first location near a first edge of the workpiece and a second location near a second edge of the workpiece opposite from said first edge of the workpiece.

3. A system as in claim 2, wherein said workpiece processing system is a laser system that cuts said workpiece at a cutting location relative to said fiducial mark location.

4. A system as in claim 1, wherein said fiducial mark includes a round portion on the workpiece.

5. A system as in claim 1, wherein said processor includes initial information indicative of an approximate initial fiducial mark location, and said processor controls said scanhead to find another location if said fiducial mark is not at said initial fiducial mark location.

6. A system as in claim 5, wherein said processor controls said find another location by spiraling outward from said initial fiducial mark location.

7. A system as in claim 1, wherein said processor includes information to find two fiducial marks at opposite corners of the workpiece to find both location and orientation of the workpiece.

8. A system as in claim 1, wherein said scanhead includes first and second galvanometer mounted mirrors, said first and second galvanometer mounted mirrors having controllable orientations that change a position of light, where said orientations are controlled by said processor.

9. A system as in claim 8, wherein the camera includes an objective lens that is optically upstream of said galvanometer mounted mirrors.

10. A system as in claim 8, wherein said camera includes an objective lens that is optically downstream of said galvanometer mounted mirrors, and where said objective lens modifies an angle of incidence of light to substantially arrive on the workpiece at a consistent angle at a number of different locations on the workpiece.

11. A system as in claim 1, wherein said processor carries out said operation to image process said to compensate for state distortion comprises carrying out a perspective distortion and piecewise bilinear interpolation.

12. A processing method, comprising:
receiving information indicative of an area being imaged on a workpiece in an electronic camera and producing an output indicative thereof;
controlling a location in at least two dimensions where the camera carries out its imaging, said controlling comprises steering an optical beam to different locations relative to a location of said camera;
using a processor for image processing said output from said camera to find a specified image feature in said output, said image processing including reducing perspective distortion in an imaged feature according to a location of said image features relative to a location of said camera; and
based on finding said image feature in said output, processing a workpiece at a location determined relative to said image feature.

13. A method as in claim 12, wherein said processing comprises laser cutting said workpiece at a location relative to a location of the image features.

14. A method as in claim 13, wherein said cutting comprises cutting off at leastone said image feature off of said workpiece.

15. A method as in claim 12, further comprising using said processor for finding two of said image features at two locations on the workpiece, including a first location near a first edge of the workpiece and a second location near a second edge of the workpiece opposite from said first edge of the workpiece.

16. A method as in claim 12, wherein said image features include a round portion on the workpiece, and said perspective distortion that is corrected is distortion which changes said round portion on the workpiece to appear as a a non-round portion in the output.

17. A method as in claim 12, further comprising storing initial information indicative of an approximate initial location of one of said image features, and controlling said location to another two-dimensional location if said image feature is not at said initial location.

18. A method as in claim 12, wherein said controlling said location comprises following a path of spiraling outward from said initial location.

19. A method as in claim 12, wherein said controlling the location comprises controlling galvanometer movable mirrors.

20. A method as in claim 12, wherein said image processing comprises carrying out a perspective transformation.

21. A method as in claim 12, further comprising calibrating said camera relative to said locations.

22. A method as in claim 12, wherein said manufacturing operation comprises inkjet printing on said workpiece at a location relative to a location of the image features.

23. A method as in claim 12, wherein said manufacturing operation comprises robotic assembly on said workpiece at a location relative to a location of the image features.

24. A workpiece processing method, comprising:
controlling a field of view of a camera to move between various locations on the surface of the workpiece;
at each of a plurality of said locations of said field of view on said surface of said workpiece, receiving information indicative of an area being imaged by said camera at said area;
defining a specified image feature;
based on said defining, using a processor for image processing said information indicative of said area to reduce perspective distortion in said information by an amount related to a distance between a center field of view of said camera and a field of view being imaged, and to find said image feature in an output from said camera;
determining a location of said feature in said output relative to a central view area of said camera, image processing said feature by an amount related to a distance between said location of said feature in said output relative to a central view area of said camera to reduce perspective distortion in said feature, and image processing said output to find said feature in said output; and
based on finding said image feature in said output, processing a workpiece.
